(19) United States
(12) Patent Application Publication
(10) Pub. No.: US 2020/0362934 A1
(43) Pub. Date: Nov. 19, 2020

(54) DAMPING VALVE FOR A VIBRATION DAMPER

(71) Applicant: ZF Friedrichshafen AG, Friedrichshafen (DE)

(72) Inventors: Aleksandar Knezevic, Eitorf (DE); Jörg Rösseler, Ruppichteroth (DE)

(73) Assignee: ZF Friedrichshafen AG, Friedrichshafen (DE)

(21) Appl. No.: 16/766,515

(22) PCT Filed: Oct. 25, 2018
(86) PCT No.: PCT/EP2018/079254

§ 371 Date: May 22, 2020

(30) Foreign Application Priority Data
Nov. 27, 2017 (DE) 10 2017 221 122.9

(51) Int. Cl. F16F 9/348; F16F 3/12; F16F 9/34; F16K 17/04

(52) U.S. Cl. CPC F16F 9/3488; F16F 3/12; F16F 2224/0208; F16K 17/0493; F16F 2224/025; F16F 9/3415

(57) ABSTRACT

A damping valve for a vibration damper includes a damping valve body having at least one through-channel which is at least partially covered by at least one valve disc, wherein the valve disc is preloaded onto a valve seat surface by a flat spring, wherein a contact region of the spring has an elastomer coating.

### CROSS-REFERENCE TO RELATED APPLICATION

This application is a national stage of International Application No. PCT/EP2018/079254 filed Oct. 25, 2018, the disclosure of which is incorporated herein by reference in its entirety, and which claimed priority to German Patent Application No. 102017221122.9, filed Nov. 27, 2017, the disclosure of which is incorporated herein by reference in its entirety.

### TECHNICAL FIELD

The present disclosure relates to a damping valve for a vibration damper.

### BACKGROUND

DE 10 2010 039 196 A1 describes a damping valve for a vibration damper, in which a tilting disc is attached to a star spring as a possible structural form of a flat spring, which tilting disc influences the spring characteristics of the star spring. In the case of a tilting disc with a larger diameter, stiffening of the star spring takes place. In addition to star springs, plate springs, which are likewise to be regarded as flat springs, are frequently used.

In DE 10 2015 206 022 A1, another approach is taken to influence the lifting behaviour of a valve disc. Elastomer elements which are held by a rigid supporting disc are used. The valve disc itself is manufactured from spring steel in the form of a simple metal disc.

In principle, damping valves in which the valve disc is relatively weakly preloaded with a view to a high level of driving comfort have a tendency towards natural vibrations. In order to avoid these natural vibrations, the at least one valve disc is preloaded more strongly than is necessary for a comfortable but still safe suspension setup.

### SUMMARY

The object of the present disclosure is to minimize this range of loss of comfort of a damping valve.

The object is achieved in that a contact region of the spring has an elastomer coating.

By means of the elastomer coating of the flat spring, resonance displacement takes place, in which a lifting movement of the valve disc is possible even with low-frequency excitations at the vibration damper without disruptive noise occurring.

With a view to simple and foolproof mounting, the spring can have an elastomer coating on both sides. The two-sided elastomer coating can, however, also be used so that the elastomer coating on a first cover side of the damping valve differs in terms of the spring rate from an elastomer coating on a second cover side. With such a coating arrangement, the lift characteristics, for example, of the valve disc can be influenced via the spring, which then lies after a specific spring travel with its second cover side against a second spring or against a supporting disc and then the second elastomer coating determines the further deformation path and thus the lift characteristics.

In principle, a plate spring known per se can be provided for the flat spring. Preferably, the flat spring is in the form of a star spring with multiple spring arms.

Not only is it possible to vary the spring rate based on a cover side of the springs; it can also be provided that the spring rate of the elastomer coating of one spring arm of the star spring differs from the spring rate of the elastomer coating of another spring arm. Supporting regions of the spring with a greater supporting force in comparison to supporting regions with a lower supporting force are then achieved. Consequently, the valve disc will, in a defined manner, always lift at the peripheral region at which the lowest supporting force is present. Undesirable noise can be avoided in this manner too.

In view of the durability of the elastomer coating, side edges of at least one spring arm also have an elastomer coating.

In addition, for better fixing of the elastomer coating, the spring arm can have a recess for receiving elastomer material.

### BRIEF DESCRIPTION OF THE DRAWINGS

FIG. 1 shows an example non-limiting vibration damper according to the present disclosure.

FIG. 2 illustrates an elastomer coating on the first cover side.

FIG. 3 shows another example of the flat spring which is in the form of a star spring with multiple spring arms.

FIG. 4 illustrates side edges of an example, non-limiting spring arm with an elastomer coating.

FIG. 5 illustrates a form-fitting connection 53.

### DETAILED DESCRIPTION

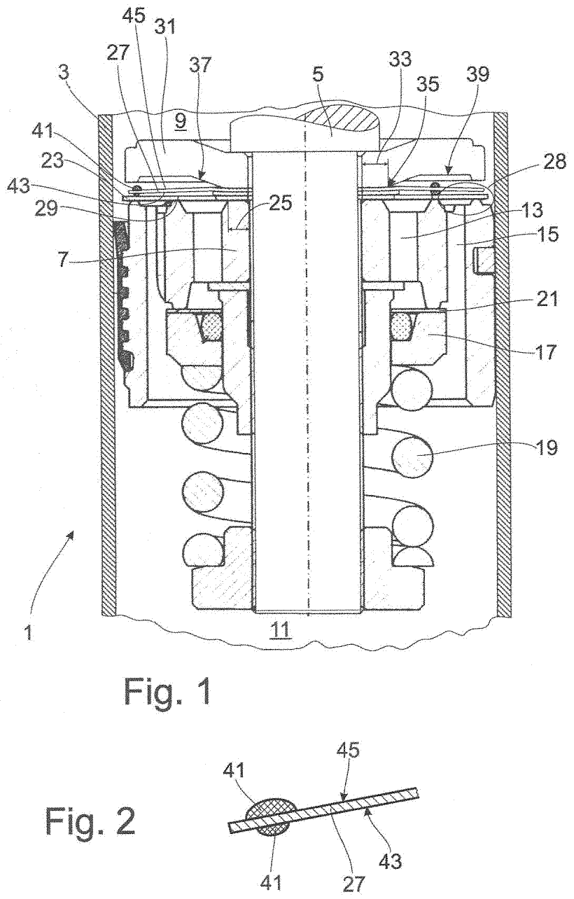

FIG. 1 shows a detail of a vibration damper 1 having a cylinder 3, filled with damping medium, in which a piston rod 5 is guided in an axially movable manner. The piston rod 5 carries a piston 7 as the damping valve body, which divides the cylinder 3 into a piston-rod-side working chamber and a piston-rod-remote working chamber 9; 11.

The piston 7 has through-channels 13; 15 for separate flow directions of the damping medium as a result of a piston rod movement. Outlet openings of the through-channels 13, on compression of the piston-rod-side working chamber 9, are at least partially covered by a rigid valve disc 17 associated with a helical compression spring 19. A so-called pre-opening disc 21 is frequently used. However, this valve construction is to be regarded only as an example.

The outlet openings for flow through the through-channels in opposite directions are at least partially covered by a valve disc 23. In this example, the valve disc is resilient in form and has a clamping region 25 at the inside diameter. Alternatively, a rigid valve disc can also be used, which lifts completely from a cover side of the damping valve body or piston 7.

The valve disc 23 is preloaded onto a valve seat surface 29 by a flat spring in the form of a plate spring 27 known per se. A rigid supporting disc 31 arranged above the plate spring 27 limits the deformation path of the plate spring 27 during a lifting movement of the valve disc 23. For this purpose, the supporting disc 31 has profiling in the direction towards the star spring 27, which profiling, starting from a clamping surface 33, extends radially outwards with an outer tilting edge 35. Adjoining the tilting edge 35 is a slope 37, which merges into a contact surface 39 for the plate spring 27. The through-channel 15 in the piston 7, together with the valve disc and the plate spring 27, forms a damping valve 28 for a movement direction of the piston 7.

Furthermore, a contact region of the plate spring 27 with the valve disc 23 has an elastomer coating, which in this case is formed on a first cover side 43 and on a second cover side 45. As is shown by a comparison of the left-and right-hand section region of the plate spring 27, the radial orientation of the elastomer coating can vary over the circumferential region. Likewise, the shaping or, for example, the coating height can likewise be irregular over the circumference.

As is shown by the detail according to FIG. 2, the elastomer coating 41 on the first cover side 43 can differ in terms of the spring rate from an elastomer coating 41 on the second cover side 45.

In the case of a lifting movement of the valve disc 23, the elastomer coating 41 and the plate spring 27 act as two springs 41; 27 connected in series. However, in comparison with a layered plate spring, metal contact between the valve disc 23 and the plate spring 27 is avoided. The same is true for contact between the plate spring 27 and the supporting disc 31. According to the spring force characteristic curve, either only the elastomer coating 41 is axially preloaded more strongly or the metallic core of the plate spring 27 is deformed. A soft basic setting of the plate spring characteristic curve 27 can be achieved without resonance vibrations of the valve disc 23 starting.

When the plate spring 27 strikes the supporting disc 31 with its upper side, or the second cover side 45, it is likewise not possible for impact noise to occur and the supporting force does not suddenly begin but increases in dependence on the geometry of the elastomer coating 41.

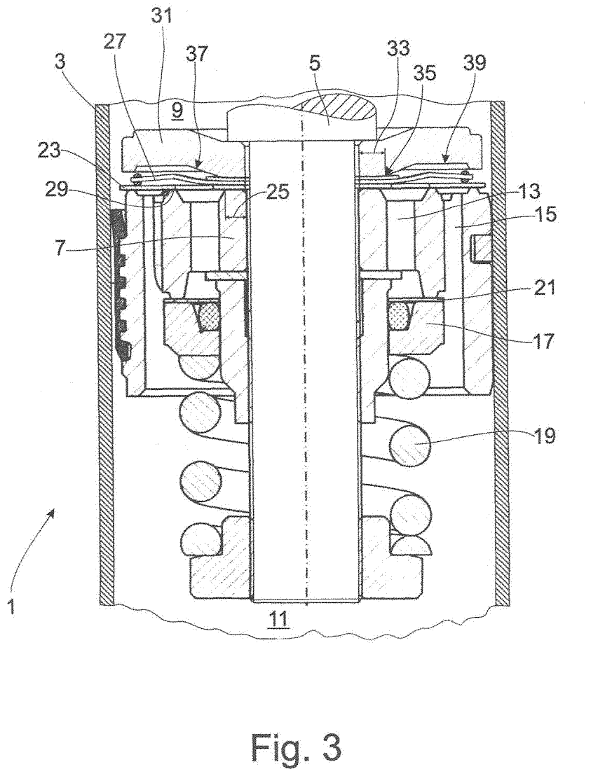

FIG. 3 is intended to show that the flat spring is not limited to a plate spring but can also be in the form of a star spring 27 with multiple spring arms 47.

With a star spring 27 it is possible to achieve even smaller closing forces and, as a result of the separation of the spring volume into multiple spring arms 47, the spring arms 47 can have different geometries and be deflected independently of one another. Furthermore, it is possible that the spring rate of the elastomer coating 41 of one spring arm 47 of the star spring 27 differs from the spring rate of the elastomer coating 41 of another spring arm 47. The difference can also lie in the choice of material, for example. The further parameters have already been listed by way of example in connection with the plate spring.

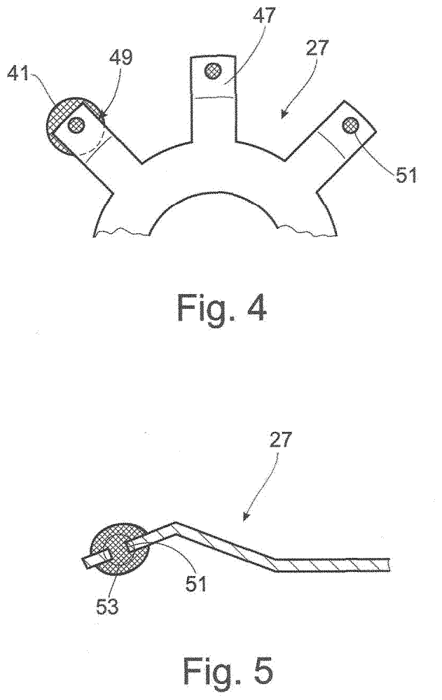

FIG. 4 is intended to show that side edges 49 of at least one spring arm 47 can also have an elastomer coating 41. A load of the elastomer coating 41 in the circumferential direction can more easily be supported via the side edge 49. In addition, the spring arm 47 can have a recess 51 for receiving elastomer material in order to achieve, in addition to a material-based connection, also a form-fitting connection with the star spring. Such a form-fitting connection 53 is shown in section in FIG. 5.

1. A damping valve for a vibration damper, comprising a damping valve body having at least one through-channel which is at least partially covered by at least one valve disc, wherein the valve disc is preloaded onto a valve seat surface by a flat spring, wherein a contact region of the spring has an elastomer coating.

2. The damping valve according to claim 1, wherein the spring has an elastomer coating on both sides.

3. The damping g valve according to claim 2, wherein the elastomer coating on the first cover side differs in terms of the spring rate from an elastomer coating on a second cover side.

4. The damping g valve according to claim 1, wherein the flat spring is in the form of a star spring with multiple spring arms.

5. The damping valve according to claim 4, wherein the spring rate of the elastomer coating of one spring arm of the star spring differs from the spring rate of the elastomer coating of another spring arm.

6. The damping valve according to claim 4, wherein the side edges of at least one spring arm have an elastomer coating.

7. The damping valve according to claim 4, wherein the spring arm has a recess for a receiving elastomer material.
